(19) United States
(12) Patent Application Publication
(10) Pub. No.: US 2013/0033145 A1
(43) Pub. Date: Feb. 7, 2013

(54) ELECTRIC MACHINE MODULE INSULATION SYSTEM AND METHOD

(71) Applicants: Daniel Randolph, Indianapolis, IN (US); Richard E. Trammell, Nobelsville, IN (US); Colin Hamer, Noblesville, IN (US)

(72) Inventors: Daniel Randolph, Indianapolis, IN (US); Richard E. Trammell, Nobelsville, IN (US); Colin Hamer, Noblesville, IN (US)

(73) Assignee: Remy Technologies, LLC, Pendleton, IN (US)

(21) Appl. No.: 13/541,528

(22) Filed: Jul. 3, 2012

Related U.S. Application Data
(60) Provisional application No. 61/514,181, filed on Aug. 2, 2011.

(51) Int. Cl. H02K 3/30

(52) U.S. Cl. 310/215

(57) ABSTRACT

Embodiments of the invention provide an electric machine module including a housing which can include a machine cavity. In some embodiments, an electric machine can be at least partially positioned within the machine cavity and can include a stator assembly. The stator assembly includes a stator core with slots. In some embodiments, conductors can be positioned in the slots and can include a first insulation. At least one insulation member can be disposed over at least a portion of the conductors. The insulation member can include a first element and a second element that can each comprise different constituent materials that include different properties.

### RELATED APPLICATIONS

This application claims priority under 35 U.S.C. §119 to U.S. Provisional Patent Application No. 61/514,181, filed on Aug. 2, 2011, the entire contents of which is incorporated herein by reference.

### BACKGROUND

Some conventional electric machines include a stator assembly disposed around a rotor assembly. Some stator assemblies include a plurality of conductors positioned within a stator core. During operation of some electric machines, a current flows through the at least some of the conductors. In order to prevent potential short circuit events and or grounding incidents, some conventional configurations for stator assemblies require multiple insulation layers between and amongst the conductors. Moreover, during operation of some electric machines, heat energy can be generated by both the stator assembly and the rotor assembly, as well as some other components of the electric machine. The increase in heat energy produced by some elements of the electric machine can lead to inefficient machine operations.

### SUMMARY

Some embodiments of the invention provide an electric machine module including a housing which can include a machine cavity. In some embodiments, an electric machine can be at least partially positioned within the machine cavity and can include a stator assembly. The stator assembly can include a stator core with slots. In some embodiments, the stator assembly can comprise a plurality of conductors that can include a first insulation. In some embodiments, at least one insulation member can be disposed over at least a portion of the plurality of conductors. In some embodiments, the insulation member can comprise a first element and a second element. In some embodiments, the first element can be positioned within the second element. In some embodiments, the first element and the second element can comprise different materials that can comprise different properties.

### DESCRIPTION OF THE DRAWINGS

FIG. 1 is a perspective view of an electric machine module according to one embodiment of the invention.

FIG. 2 is a perspective view of an electric machine module according to one embodiment of the invention.

FIG. 3 is a perspective view of a stator assembly according to one embodiment of the invention.

FIG. 4 is front view of a stator lamination according to one embodiment of the invention.

FIG. 5 is a perspective view of a conductor according to one embodiment of the invention.

FIGS. 6A and 6B are cross-sectional views of a slot according to some embodiments of the invention.

FIG. 7 is a side view of a portion of a stator assembly according to some embodiments of the invention.

FIG. 8 is an expanded side view of the stator assembly of FIG. 7.

FIG. 9 is a top view of the stator assembly of FIG. 7.

FIG. 10 is top view of the stator assembly of FIG. 7.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

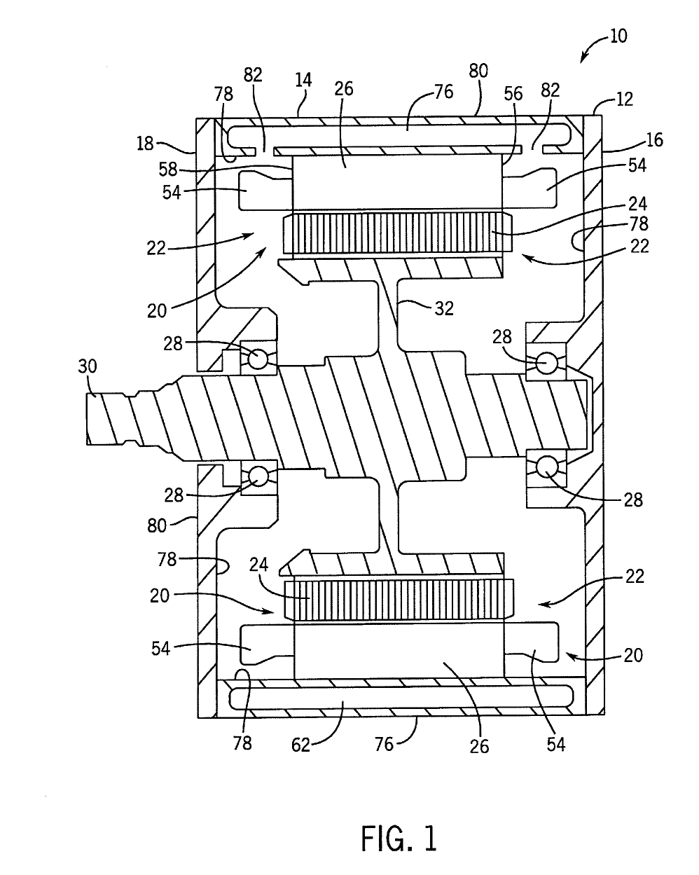

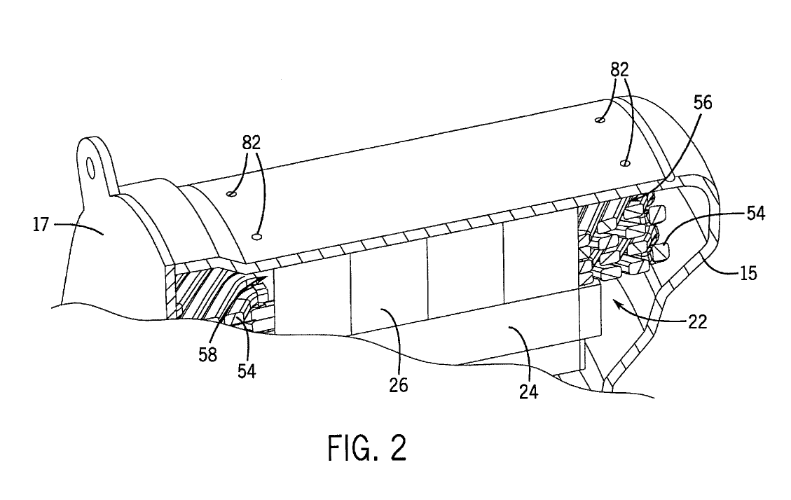

FIGS. 1 and 2 illustrate an electric machine module 10 according to one embodiment of the invention. The module 10 can include a housing 12 comprising a sleeve member 14, a first end cap 16, and a second end cap 18. An electric machine 20 can be housed within a machine cavity 22 at least partially defined by the sleeve member 14 and the end caps 16, 18. For example, the sleeve member 14 and the end caps 16, 18 can be coupled via conventional fasteners (not shown), or another suitable coupling method, to enclose at least a portion of the electric machine 20 within the machine cavity 22. In some embodiments, the housing 12 can comprise a substantially cylindrical canister 15 coupled to an end cap 17, as shown in FIG. 2. Further, in some embodiments, the housing 12 can comprise materials that can generally include thermally conductive properties, such as, but not limited to aluminum or other metals and materials capable of generally withstanding operating temperatures of the electric machine. In some embodiments, the housing 12 can be fabricated using different methods including casting, molding, extruding, and other similar manufacturing methods.

The electric machine 20 can include a rotor assembly 24, a stator assembly 26, and bearings 28, and can be disposed about a shaft 30. As shown in FIG. 1, the stator assembly 26 can substantially circumscribe at least a portion of the rotor assembly 24. In some embodiments, the rotor assembly 24 can also include a rotor hub 32 or can have a “hub-less” design (not shown).

In some embodiments, the electric machine 20 can be operatively coupled to the housing 12. For example, the electric machine 20 can be fit within the housing 12. In some embodiments, the electric machine 20 can be fit within the housing 12 using an interference fit, a shrink fit, other similar friction-based fits that can at least partially operatively couple the machine 20 and the housing 12. For example, in some embodiments, the stator assembly 26 can be shrunk fit into the module housing 12. Further, in some embodiments, the fit can at least partially secure the stator assembly 26, and as a result, the electric machine 20, in axial, radial and circumferential directions. In some embodiments, during operation of the electric machine 20 the fit between the stator assembly 26 and the housing 12 can at least partially serve to transfer torque from the stator assembly 26 to the housing 12. In some embodiments, the fit can result in a generally greater amount of torque retained by the module 10.

The electric machine 20 can be, without limitation, an electric motor, such as a hybrid electric motor, an electric generator, or a vehicle alternator. In one embodiment, the electric machine 20 can be a High Voltage Hairpin (HVH) electric motor, an interior permanent magnet electric motor, or an induction motor for hybrid vehicle applications.

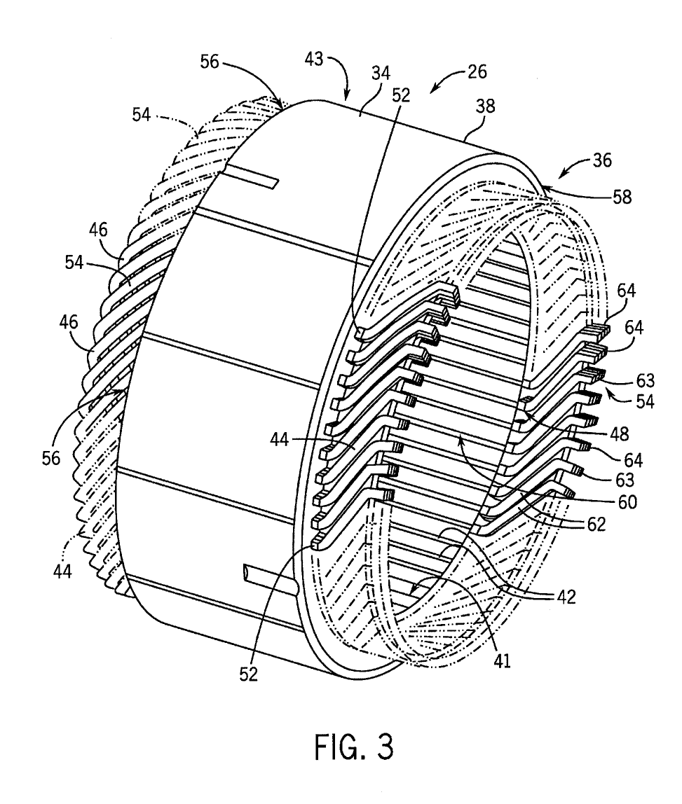

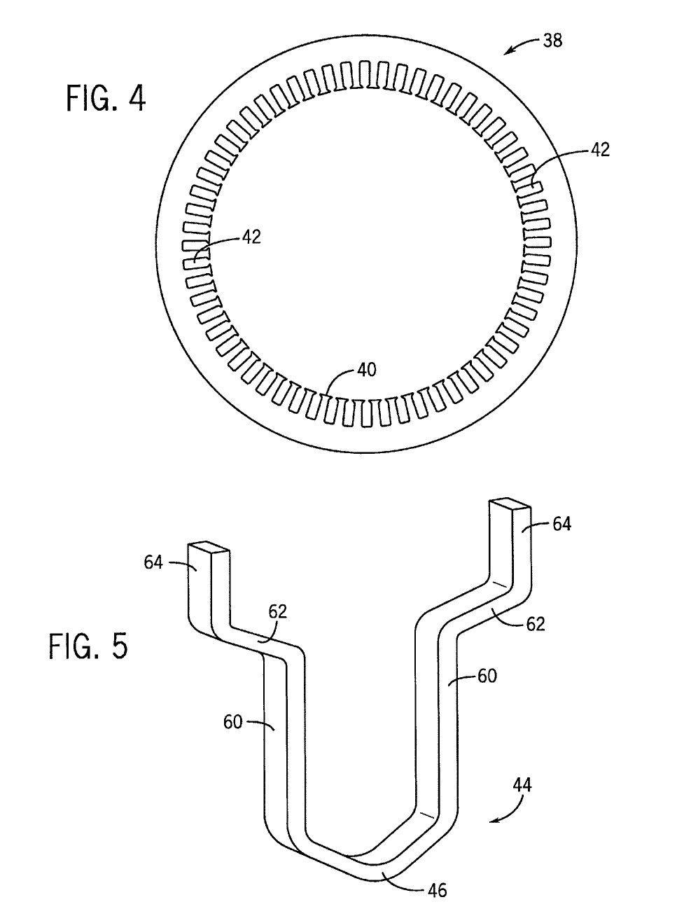

As shown in FIG. 3, in some embodiments, the stator assembly 26 can comprise a stator core 34 and a stator winding 36 at least partially disposed within a portion of the stator core 34. For example, in some embodiments, the stator core 34 can comprise a plurality of laminations 38. Referring to FIG. 4, in some embodiments, the laminations 38 can comprise a plurality of substantially radially-oriented teeth 40. In some embodiments, as shown in FIG. 3, when at least a portion of the plurality of laminations 38 are substantially assembled, the teeth 40 can substantially align to define a plurality of slots 42 that are configured and arranged to support at least a portion of the stator winding 36. As shown in FIG. 4, in some embodiments, the laminations 38 can include sixty teeth 40, and, as a result, the stator core 28 can include sixty slots 42. In other embodiments, the laminations 38 can include more or fewer teeth 40, and, accordingly, the stator core 34 can include more or fewer slots 42. Moreover, in some embodiments, the stator core 34 can comprise an inner perimeter 41 and an outer perimeter 43. For example, in some embodiments, the stator core 34 can comprise a substantially cylindrical configuration so that the inner and outer perimeters 41, 43 can comprise inner and outer diameters, respectively. However, in other embodiments, the stator core 34 can comprise other configurations (e.g., square, rectangular, elliptical, regular or irregular polygonal, etc.), and, as a result, the inner and outer perimeters 41, 43 can comprise other dimensions.

In some embodiments, the stator winding 36 can comprise a plurality of conductors 44. In some embodiments, the conductors 44 can comprise a substantially segmented configuration (e.g., a hairpin configuration), as shown in FIGS. 3 and 5. For example, in some embodiments, at least a portion of the conductors 44 can include a turn portion 46 and at least two leg portions 48. In some embodiments, the turn portion 46 can be disposed between the two leg portions 48 to substantially connect the two leg portions 48. In some embodiments, the leg portions 48 can be substantially parallel. Moreover, in some embodiments, the turn portion 46 can comprise a substantially “u-shaped” configuration, although, in some embodiments, the turn portion 46 can comprise a v-shape, a wave shape, a curved shape, and other shapes. Additionally, in some embodiments, as shown in FIG. 5, at least a portion of the conductors 44 can comprise a substantially rectangular cross section. In some embodiments, at least a portion of the conductors 44 can comprise other cross-sectional shapes, such as substantially circular, square, hemispherical, regular or irregular polygonal, etc. In some embodiments, the conductors 44 can comprise other configurations (e.g., substantially non-segmented configuration).

In some embodiments, the stator assembly 26 can comprise one or more insulating members, apparatuses, and/or other structures configured and arranged to provide mechanical, electrical, and physical insulation to some portions of the stator assembly 26. In some embodiments, at least a portion of some of the conductors 44 can comprise a first insulation 50. For example, in some embodiments, the first insulation 50 can comprise a resinous material such as an epoxy or an enamel that can be reversibly or irreversibly coupled to at least a portion of the conductors 44. In some embodiments, because an electrical current circulates through the conductors 44 during operation of the electric machine 20, the first insulation 50 can function, at least in part, to substantially prevent short circuits and/or grounding events between neighboring conductors 44 and/or conductors 44 and the stator core 34.

In some embodiments, the first insulation 50 can comprise a shrunk-fit structure coupled to at least some of the conductors 44 so that the first insulation 50 is retained when the conductors 44 are disposed within the stator core 28. In some embodiments, the first insulation 50 can be wrapped, wound, or otherwise disposed on, or coupled to, the conductors (e.g., via an adhesive). In some embodiments, as discussed further below, at least a portion of the conductors 44 can substantially function without some or all of the first insulation 50.

In some embodiments, the conductors 44 can be generally fabricated from a substantially linear conductor 44 that can be configured and arranged to a shape substantially similar to the conductor in FIG. 5. For example, in some embodiments, a machine (not shown) can apply a force (e.g., bend, push, pull, other otherwise actuate) to at least a portion of a conductor 44 to substantially form the turn portion 46 and the two leg portions 48 of a single conductor 44. In some embodiments, at least a portion of the conductors 44 can be configured into a desired shape after coupling of the first insulation 50 to the conductors 44. Although, in some embodiments, at least a portion of the conductors 44 can be configured (e.g., bent, pushed, pulled, etc.) into a desired shape (e.g., a hairpin) and then the first insulation 50 can be coupled to the conductors 44.

In some embodiments, the stator assembly 26 can comprise a second layer of insulation. In some embodiments, the second layer of insulation can comprise at least one slot member 52. In some embodiments, the stator assembly 26 can comprise at least one slot member 52 disposed in one or more of the slots 42. For example, one or more slot members 52 can be disposed in some or all of the slots 42. In some embodiments, each slot 42 can comprise at least one slot member 52. In some embodiments, at least a portion of the slot members 52 can comprise a substantially cylindrical shape. In some embodiments, the slot members 52 can comprise other shapes, such as square, rectangular, hemispherical, regular or irregular polygonal, etc. In some embodiments, at least a portion of the slot members 52 can comprise any shape desired and/or needed by the manufacturer or user. Moreover, in some embodiments, the slot members 52 can be configured and arranged to receive at least a portion of one or more conductors 44, as described in further detail below.

In some embodiments, the slot member 52 can comprise materials that can resist abrasion, can provide electrical and/or mechanical insulation, can comprise thermally-conductive properties, and/or can comprise other properties desired by a manufacturer or user. For example, in some embodiments, at least a portion of the slot members 52 can comprise materials such as polyimides (e.g., Kapton®), polyamides, polyester, polyamideimide, polyethylene terephthalate film (e.g., Mylar®), para-aramid (e.g., Kevlar®), meta-aramid (e.g., Nomex®) or other materials. In some embodiments, the slot member 52 can comprise a composite of some or all of the previously mentioned materials, such as a Nomex®-Katpton® composite.

In some embodiments, as shown in FIG. 3, at least a portion of the conductors 44 can be positioned substantially within the slots 42. For example, in some embodiments, the stator core 34 can be configured so that the plurality of slots 42 are substantially axially arranged. In some embodiments, the leg portions 48 can be inserted into the slots 42 so that at least some of the leg portions 48 can axially extend through the stator core 34. In some embodiments, the leg portions 48 can be inserted into neighboring slots 42. For example, in some embodiments, the leg portions 48 of a conductor 44 can be disposed in slots that are distanced approximately one magnetic-pole pitch apart (e.g., six slots, eight slots, etc.). In some embodiments, a plurality of conductors 44 can be disposed in the stator core 34 so that at least some of the turn portions 46 of the conductors 44 axially extend from the stator core 34 at an insertion end 56 of the stator assembly 26 and at least some of the leg portions 48 axially extend from the stator assembly 26 at a weld end 58 of the stator core 34. In some embodiments, at least a portion of the conductor 44 regions that axially extend from the stator assembly 26 at the ends 56, 58 can comprise stator end turns 54.

In some embodiments, one or more slot members 52 can be disposed within some or all of the slots 42 during assembly of the module 10. In some embodiments, the slot members 52 can be disposed within the slots 42 prior to one or more of the conductors 44 being disposed within the stator core 34. For example, in some embodiments, the slot members 52 can be positioned within the slots 42 so that at least a portion of some of the conductors 44 (e.g., the leg portions 48) can be at least partially disposed within the slot members 52. By way of example only, in some embodiments, one or more slot members 52 can be disposed within each of the slots 42 so that the slot members 52 can receive at least a portion of each of the conductors 44.

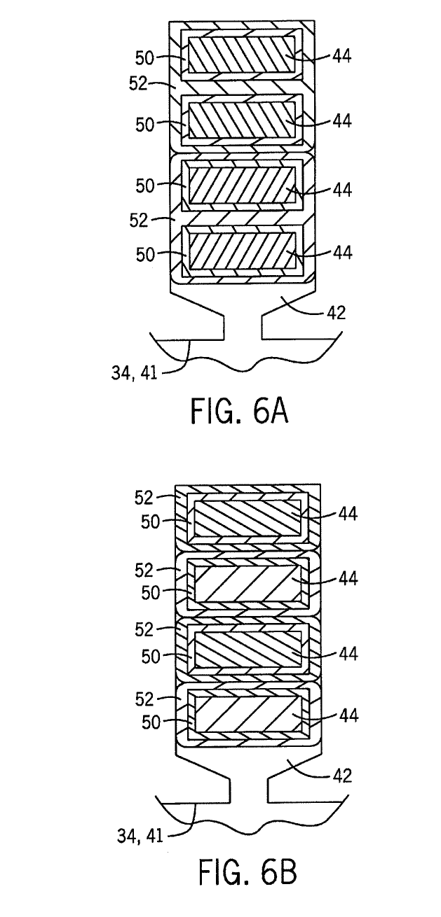

Moreover, in some embodiments, one slot member 52 can receive one or more conductors. In some embodiments, one slot member 52 can be configured and dimensioned to receive two or more conductors 44. For example, in some embodiments, at least a portion of the slot members 52 can be configured and arranged to receive two conductors (e.g., a leg portion 48 of two different conductors 44 or both leg portions 48 of the same conductor 44), as shown in FIG. 6A. As a result, in some embodiments, at least a portion of the slots 42 can comprise four conductors 44 and two slot members 52 (e.g., portions of two conductors 44 disposed in a slot member 52). In some embodiments, at least a portion of the slots 42 can comprise the same number of slot members 52 as conductors 44. For example, in a slot 42 including portions of four conductors 44, the slot 42 can comprise four or more slot members 52, as shown in FIG. 6B. Furthermore, in some embodiments, the stator assembly 26 can comprise any combination of any of the foregoing slot member 52/conductor 44 ratios. For example, some slots 42 can comprise four slot members 52 and four conductors 44, some slots 42 can comprise two slot members 52 and four conductors 44, and some slots can comprise one or more than one slot members 52 and four conductors 44. As previously mentioned, the use of four conductors 44 is exemplary and other number of conductors 44 (e.g., one, two, six, eight, etc.) can be disposed within the slots 42.

In some embodiments, at least some of the leg portions 48 can comprise multiple regions. In some embodiments, the leg portions 48 can comprise in-slot portions 60, angled portions 62, and connection portions 64. In some embodiments, as previously mentioned, the leg portions 48 can be disposed in the slots 42 and some regions of the leg portions 48 (e.g., the in-slot portions 60) can be at least partially received within the slot members 52. Moreover, the leg portions 48 can axially extend from the insertion end 56 to the weld end 58. In some embodiments, after insertion, at least a portion of the leg portions 48 positioned within the stator core 34 can comprise the in-slot portions 60.

In some embodiments, at least some regions of the leg portions 48 extending from stator assembly 26 at the weld and insertion ends 56, 58 can comprise the angled portions 62 and the connection portions 64. In some embodiments, after inserting the conductors 44 into the stator core 34, the leg portions 48 extending from the stator core 34 can undergo a conventional twisting process (not shown) which can lead to the creation of the angled portions 62 and the connection portions 64. For example, in some embodiments, the twisting process can locate the angled portions 62 at a more axially inward position and the connection portions 64 at a more axially outward position, as shown in FIG. 3. In some embodiments, the angled portions 62 can comprise other configurations, such as bent, curved, or otherwise removed from a horizontal axis of the conductors 44.

In some embodiments, after the twisting process, the connection portions 64 of at least a portion of the conductors 44 can be immediately adjacent to connection portions 64 of other conductors 44. As a result, the connection portions 64 can be coupled together to form one or more stator windings 36. In some embodiments, the connection portions 64 can be coupled via welding, brazing, soldering, melting, adhesives, or other coupling methods. Additionally, in some embodiments, at least a portion of the first insulation 50 can be substantially removed at the connection portions 64 in order to enable the coupling process. Although, in some embodiments, the first insulation 50 can be coupled to the conductors 44 so that it does not coat and/or cover the connection portions 64.

In some embodiments, the module 10 can comprise a plurality of electrical phases. For example, in some embodiments, the module 10 can comprise three phases for enhanced operations of the electric machine 20. As a result, in some embodiments, the connection portions 64 can be connected to neighboring connection portions 64 so that the they are configured and arranged to from three different electrical phases. In some embodiments, the stator winding 36 can comprise a wye and/or a delta configuration. Furthermore, in some embodiments, each of the phases can be connected to a conventional terminal (e.g., a structure comprising conductive properties that can be coupled to an electrical source and/or an apparatus that can receive current generated by the stator winding 36). For example, in some embodiments, the stator assembly 26 can comprise a terminal region 66 and the terminal region 66 can be configured and arranged so that each phase can be coupled to a different terminal (i.e., a stator assembly 26 including three phases can include three terminals).

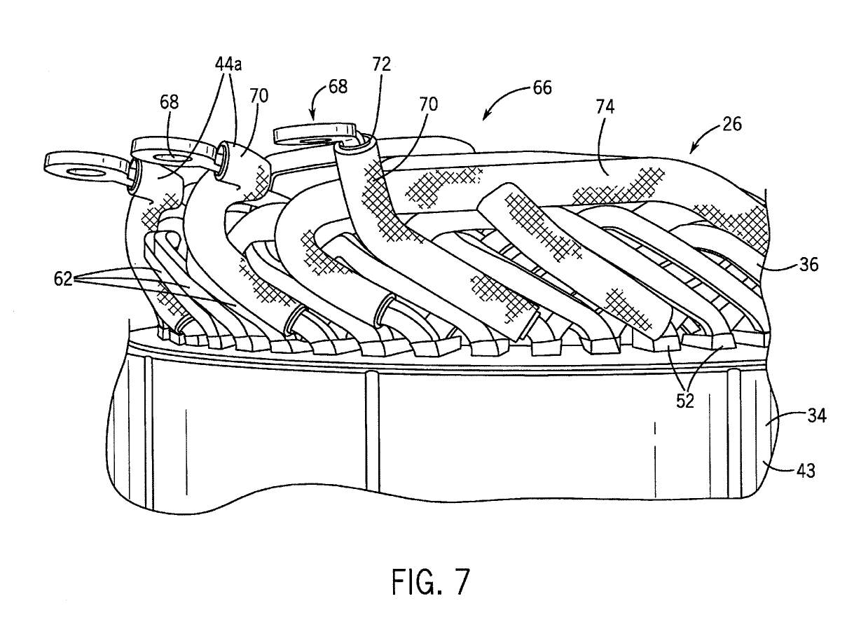

In some embodiments, the ten final region 66 can comprise a plurality of terminal region conductors 44, 44a configured in alternative manners. For example, in some embodiments, in order to connect the conductors 44a in a desired configuration (e.g., a wye-configured or a delta-configured three-phase winding 36), at least a portion of the conductors 44a can be bent, pushed, pulled, other otherwise actuated to give rise to forms that can fit within the module 10, as shown in FIG. 7. For example, in some embodiments, at least a portion of the conductors 44a of the terminal region 66 can be differently configured than some of the conductors 44 that comprise at least some other portions of the stator winding 36. By way of example only, some of these terminal region conductors 44a can comprise regular and/or irregular shapes to fit adjacent to other conductors 44 and to be able to be positioned within the housing 12. Moreover, in some embodiments, at least a portion of the terminal region conductors 44a can comprise one or more apertures 68, as shown in FIG. 7. For example, in some embodiments, the terminals can be coupled to, positioned within, or otherwise engage the apertures 68 so that current can flow between the stator winding 36 and the terminals.

In some embodiments, during the life of the module 10, at least some conductors 44, 44a can contact other conductors 44, including the terminal region conductors 44a, the stator core 34, the housing 12, and other elements of the module 10, which can cause wear upon the conductors 44, 44a. For example, in some conventional electric machines, the wear can lead to the breakdown of the first insulation 50 so that, over time, a bare portion of the conductors 44, 44a can be exposed, which can lead to grounding events and/or potential short circuits. In some embodiments, the first insulation 50 can at least partially wear down as a result of the twisting process. For example, in some embodiments, pressure points created by the twisting process can create areas of the first insulation 50 that receive more mechanical stress relative to other portions of the first insulation 50. Over the course of the life of the module 10, the first insulation 50 can wear, and, under some circumstances, the first insulation 50 can eventually become compromised. As a result of wear of the first insulation 50, in some embodiments, bare conductors 44, 44a (e.g., bare copper or bare copper-containing materials) can contact each other, the stator core 34, the housing 12, or other elements, which can lead to malfunctioning of the module 10 (e.g., short circuit events, grounding events, etc.).

In order to at least partially reduce the risk of short circuit and/or grounding events due to conductor 44 wear, in some embodiments, at least a portion of the stator assembly 26 can comprise at least one insulation member 70. In some embodiments, the stator assembly 26 can comprise a plurality of insulation members 70. In some embodiments, the insulation member 70 can comprise different configurations. For example, in some embodiments, the insulation member 70 can comprise a tape, a dip, a varnish, a single-layered insulation member, a compound insulation member, or other insulation configurations.

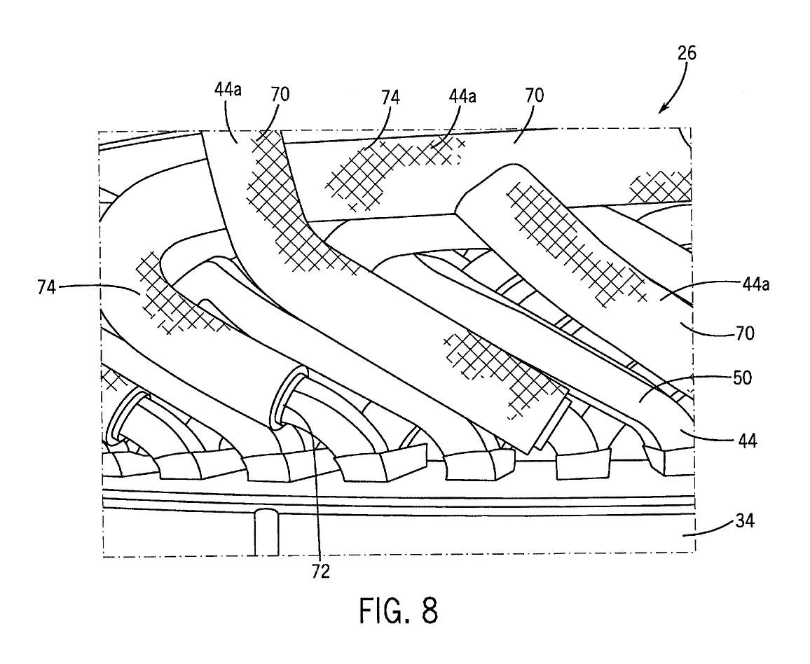

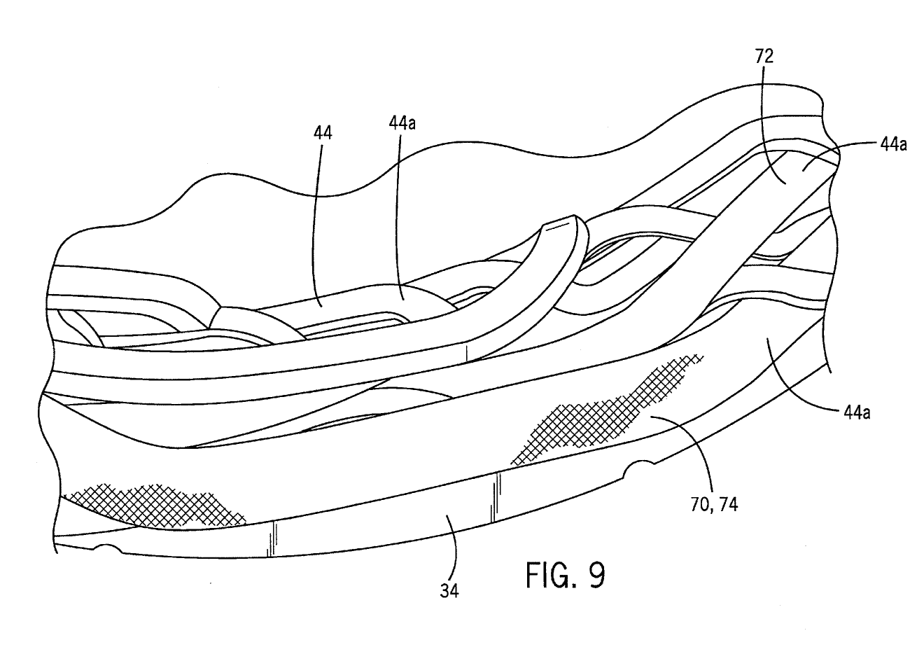

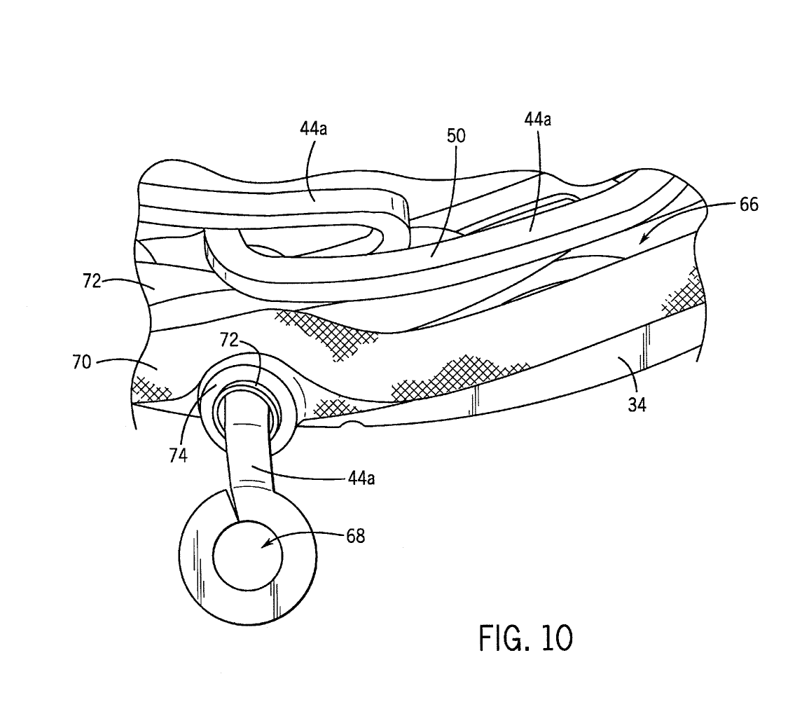

By way of example only, in some embodiments, the insulation member 70 can comprise a compound insulation member 70. In some embodiments, the compound insulation member 70 can comprise at least a first element 72 reversibly or irreversibly coupled to a second element 74, as described in further detail below. In some embodiments, the insulation member 70 can be positioned over and/or around some portions of the conductors 44, including at least a portion of the terminal region conductors 44a. For example, as shown in FIGS. 7-10, in some embodiments, the insulation member 70 can be positioned over some portions of the terminal region conductors 44a so that during the life span of the module 10, short circuits and/or grounding events stemming from contact of the conductors 44, 44a with adjacent conductors 44, 44a can be at least partially reduced.

Moreover, in some embodiments, at least a portion of the conductors 44, 44a can comprise an insulation member 70 where the conductors 44, 44a change direction (e.g., a bend in the conductors 44, 44a) to at least partially compensate for any weaknesses in the first insulation 50. For example, in some embodiments, as previously mentioned, the conductors 44, 44a can be bent, angled, moved, or otherwise actuated to fit within the housing 12 and to enable configuration of the stator winding 36. As a result, in some embodiments, the first insulation 50 covering the portion of the conductors 44, 44a that receives the actuation (i.e., the bent region) can be at least partially weakened by the actuation process. Accordingly, over time, the structural integrity of the first insulation 50 at that position can be reduced, which can lead to an increased risk of ground events and/or short circuits because of the exposed conductor 44, 44a, which can be prevented by the inclusion of one or more insulation members 70.

In some embodiments, the insulation members 70 can be configured and arranged to at least partially enhance insulation of at least some portions of the stator assembly 26. As previously mentioned, in some embodiments, the insulation member 70 can include at least two elements 72, 74, although, in other embodiments, the insulation member 70 can comprise more than two elements. For example, in some embodiments, the insulation member 70 can comprise the first element 72 operatively coupled to the second element 74. In some embodiments, as detailed below, the first and the second elements 72, 74 can comprise different materials that can include different properties.

In some embodiments, the first element 72 can comprise different materials. In some embodiments, the first element 72 can comprise at least one of fiberglass, Kevlar®, Nomex®, polyamide, polyimide, any organic (e.g., silk and/or cotton) or inorganic fibers, other constituents capable of providing physical, electrical, thermal, and/or chemical insulation, or any combination thereof. Moreover, in some embodiments, the first element 72 can comprise a material capable of being spun like a fiber. By way of example only, in some embodiments, the first element 72 can comprise fiberglass that has been woven to form a sleeve-like structure. Moreover, in some embodiments, the first element 72 can comprise a plurality of layers coupled together to form the first element 72. In some embodiments, the first element 72 can be configured and arranged so that at least a portion of at least one of the conductors 44, 44a can extend through a portion of the first element 72 (e.g., the first element 72 can comprise a sleeve-like configuration, as shown in FIGS. 7-10).

In some embodiments, the second element 74 can comprise different materials. In some embodiments, the second element 74 can comprise at least one of fiberglass, Kevlar®, Nomex®, polyamide, polyimide, any organic (e.g., silk and/or cotton) or inorganic fibers, other constituents capable of providing physical, electrical, thermal, and/or chemical insulation, or any combination thereof. Moreover, in some embodiments, the second element 74 can comprise a material capable of being spun like a fiber or can be spun into a fiber. By way of example only, in some embodiments, the second element 74 can comprise Kevlar® that has been woven or otherwise configured to form a sleeve-like structure. Moreover, in some embodiments, the second element 74 can comprise a plurality of layers coupled together to form the second element 74. In some embodiments, the second element 74 can be configured and arranged so that at least a portion of the first element 72 can be positioned within the second element 74.

In some embodiments, the first and the second elements 72, 74 can comprise other configurations. For example, in some embodiments, the first element 72 can comprise Nomex® and the second element 74 can comprise Kevlar®, polyamide, or any other material. Moreover, in some embodiments, the selection of the materials used in fabrication of the elements 72, 74 can be at least partially correlated with the desired insulative capabilities of the materials. For example, in some embodiments, Kevlar® can at least partially enhance the abrasion resistance of the insulation member 70. In some embodiments, Nomex® can enhance heat resistance and polyamide can at least partially improve the dielectric strength of the insulation member 70. In some embodiments, any other materials capable of providing desired insulation in the environment of the machine cavity 22 can be used in fabricating the insulation member 70.

In some embodiments, the first and the second elements 72, 74 can be coupled together to form the insulation member 70. The first and the second elements 72, 74 can be coupled in different manners, including, but not limited to adhesives, conventional fasteners, interference fitting, etc. By way of example only, in some embodiments, the first and the second elements 72, 74 can be coupled together via an adhesive. In some embodiments, after fabrication of at least a portion of the elements 72, 74, the adhesive can be applied to an outer perimeter of the first element 72 (e.g., an outer diameter) and/or an inner perimeter of the second element 74 (e.g., an inner diameter) to aid in the coupling process. In some embodiments, after applying the adhesive, the first and the second elements 72, 74 can be exposed to an environment including an elevated temperature, which can lead to curing of the adhesive. As a result, in some embodiments, the first and the second elements 72, 74 can be coupled together (i.e., bonded) to form the insulation member 70. In some embodiments, the adhesive can comprise a non-silicone composition so that the adhesive does not interfere with any module 10 operations, including coolant circulation, as described in further detail below.

Moreover, in some embodiments, the first element 72 can be coupled to the second element 74 prior to positioning on the stator winding 36. Although, in other embodiments, the first element 72 can be positioned over at least a portion of a conductor 44, 44a and the second element 74 can then be coupled to the first element 72. In some embodiments, the insulation member 70 can be positioned over portions of the terminal region conductors 44a, although, in other embodiments, the insulation member 70 can be positioned over any other portions of any other conductors 44 that comprise the stator winding 36. Additionally, in some embodiments, at least a portion of the insulation member 70 can be positioned prior to positioning of at least some of the conductors 44, 44a. For example, in some embodiments, the insulation member 70 can be positioned over a portion of some of the conductors 44, 44a and then the conductors 44, 44a can be placed in position for assembly of the stator winding 36. Moreover, in some embodiments, the insulation member 70 can be positioned after at least a portion of the conductors 44, 44a are positioned to form the stator winding 36.

Moreover, in some embodiments, the stator assembly 26 can comprise additional insulation, including a varnish that can provide physical and/or electrical insulation for the stator winding 36. For example, in some embodiments, the varnish (e.g., a resin, such as epoxy, or other insulating material) can be applied to the stator assembly 26 via vacuum pressure impregnation in a manner substantially similar to the process disclosed in U.S. patent application Ser. No. 13/233,187, which is owned by the assignee of the present application and is incorporated herein by reference in its entirety. Moreover, in some embodiments, the varnish can be applied to the stator assembly 26 in other manners, such as using other active and passive methods (e.g., gravity-based methods, submersion methods, etc.). In addition to insulating capabilities, in some embodiments, the varnish can also provide structural stability to the stator assembly 26 so that after coating at least some portions of the assembly 26 with the varnish, some portions of the stator assembly 26 (e.g., the slot members 52, the insulation members 70) can possess greater structural strength relative to the pre-varnish stator assembly 26 and can be further bonded together.

As shown in FIG. 1, in some embodiments, the housing 12 can comprise at least a portion of a coolant jacket 76. For example, in some embodiments, the sleeve member 14 can include an inner surface 78 and an outer surface 80 and the coolant jacket 76 can be positioned substantially between the surfaces 78, 80. In some embodiments, the coolant jacket 76 can substantially circumscribe at least a portion of the electric machine 20. For example, in some embodiments, the coolant jacket 76 can substantially circumscribe at least a portion of the outer diameter 43 of the stator assembly 26, including the stator winding 36 as it extends on both the insertion end 56 and the weld end 58 (e.g., the stator end turns 54).

Further, in some embodiments, the coolant jacket 76 can contain a coolant that can comprise transmission fluid, ethylene glycol, an ethylene glycol/water mixture, water, oil, motor oil, a mist, a gas, or another substance capable of receiving heat energy produced by the electric machine module 10. The coolant jacket 76 can be in fluid communication with a coolant source (not shown) which can pressurize the coolant prior to or as it is being dispersed into the coolant jacket 76, so that the pressurized coolant can circulate through the coolant jacket 76.

Also, in some embodiments, the inner surface 78 can include coolant apertures 82 so that the coolant jacket 74 can be in fluid communication with the machine cavity 22. In some embodiments, the coolant apertures 82 can be positioned substantially adjacent to the stator winding 36 as it exits the stator core 34 on at least one of the weld end 58 and the insertion end 56. For example, in some embodiments, as the pressurized coolant circulates through the coolant jacket 76, at least a portion of the coolant can exit the coolant jacket 76 through the coolant apertures 82 and enter the machine cavity 22. Also, in some embodiments, the coolant can contact the stator winding 36, which can lead to at least partial cooling. After exiting the coolant apertures 82, at least a portion of the coolant can flow through portions of the machine cavity 22 and can contact various module 10 elements, which, in some embodiments, can lead to at least partial cooling of the module 10.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine module comprising:
a housing at least partially defining a machine cavity;
an electric machine at least partially positioned within the machine cavity and at least partially enclosed by the housing, the electric machine including a stator assembly including a stator core and a stator winding, the stator winding comprising a plurality of conductors, and the plurality of conductors comprising a first insulation; and
at least one insulation member being disposed over at least a portion of plurality of conductors, the insulation member comprising a first element and a second element, the first element being positioned within the second element, and wherein the first element and the second element comprise different materials comprising different properties.

2. The electric machine module of claim 1, wherein the first insulation comprises a resinous material.

3. The electric machine module of claim 1, wherein the stator core comprises a plurality of slots and at least some of the plurality of conductors are positioned within the plurality of slots.

4. The electric machine module of claim 3 and further comprising at least one slot member disposed within each of the plurality of slots, and wherein at least some portions of the plurality of conductors are positioned within the slot members.

5. The electric machine module of claim 1, wherein the first element comprises at least one of fiberglass, Kevlar®, Nomex®, polyamide, polyimide, silk, cotton, an organic fiber, and an inorganic fibers.

6. The electric machine module of claim 5, wherein the second element comprises at least one of fiberglass, Kevlar®, Nomex®, polyamide, polyimide, silk, cotton, an organic fiber, and an inorganic fibers.

7. The electric machine module of claim 1, wherein the first element comprises a plurality of woven layers of fiberglass.

8. The electric machine module of claim 7, wherein the second element comprises a plurality of woven layers of at least one of Kevlar®, Nomex®, and polyamide.

9. The electric machine module of claim 1, wherein stator winding comprises a terminal region, and wherein the terminal region comprises a plurality of terminal region conductors that are differently configured than the plurality of conductors.

10. The electric machine module of claim 9, wherein the terminal region conductors comprise a plurality of insulation members.

11. The electric machine module of claim 1, wherein the housing comprises at least a portion of a coolant jacket that is in fluid communication with the machine cavity.

12. An electric machine module comprising:
a housing including a machine cavity and at least a portion of a coolant jacket that is in fluid communication with the machine cavity;
an electric machine being at least partially positioned within the machine cavity and at least partially enclosed by the housing, the electric machine including a stator assembly including a stator winding, the stator winding comprising a plurality of conductors, and the plurality of conductors comprising a first insulation; and
at least one insulation member being disposed over at least a portion of plurality of conductors, the insulation member comprising a first element and a second element, the first element being coupled to the second element using an adhesive, the first element and the second element each comprising at least one of fiberglass, Kevlar®, Nomex®, polyamide, polyimide, silk, cotton, an organic fiber, and an inorganic fibers, and wherein the first element and the second element comprise different materials.

13. The electric machine module of claim 12, wherein the stator assembly is positioned within the housing so that the coolant jacket circumscribes at least a portion of the stator assembly.

14. The electric machine module of claim 12, wherein the first insulation comprises a resinous material.

15. The electric machine module of claim 12, wherein the stator assembly comprises a plurality of slots and at least some of the plurality of conductors are positioned within the plurality of slots.

16. The electric machine module of claim 15 and further comprising at least one slot member disposed within each of the plurality of slots, and wherein at least some portions of the plurality of conductors are positioned within the slot members.

17. The electric machine module of claim 12, wherein stator winding comprises a terminal region, and wherein the terminal region comprises a plurality of terminal region conductors that are differently configured than the plurality conductors.

18. The electric machine module of claim 17, wherein only the terminal region conductors comprise insulation members.

19. A method of assembling a stator assembly, the method comprising:
providing a plurality of stator laminations including a plurality of teeth;
coupling together at least a portion of the plurality of stator laminations so that the plurality of teeth substantially axially align to form a plurality of slots and the laminations forms a stator core;
disposing at least one slot member within each of the plurality of slots;
assembling a first element from at least one of fiberglass, Kevlar®, Nomex®, polyamide, polyimide, silk, cotton, an organic fiber, and an inorganic fibers;
assembling a second element from at least one of fiberglass, Kevlar®, Nomex®, polyamide, polyimide, silk, cotton, an organic fiber, and an inorganic fibers, wherein the second element and the first element comprise different materials;
coupling together an outer diameter of the first element and an inner diameter of the second element using an adhesive to form at least one insulation member;
disposing at least one insulation member over at least one conductor so that that the first element is immediately adjacent to an outer surface of the at least one conductor; and
forming a stator winding at least partially supported by the stator core, the stator winding including the at least one conductor and the at least one insulation member.

20. The method of claim 19, wherein the first element comprises woven fiberglass and the second element comprises at least one of Kevlar®, Nomex®, and polyamide.
